(19) United States
(12) Patent Application Publication
(10) Pub. No.: US 2018/0074336 A1
(43) Pub. Date: Mar. 15, 2018

(54) 3D IMAGING METHOD AND DEVICE

(71) Applicant: GUANGZHOU UC NETWORK TECHNOLOGY CO., LTD., Guangzhou City (CN)

(72) Inventors: Jie LIANG, Guangzhou City (CN); Yankun ZHEN, Guangzhou City (CN)

(21) Appl. No.: 15/563,755

(22) PCT Filed: Apr. 1, 2016
(86) PCT No.: PCT/CN2016/078251

§ 371 Date: Oct. 2, 2017

(30) Foreign Application Priority Data
Jun. 29, 2015 (CN) 201510372512.5

(51) Int. Cl. G02B 27/26; G02B 27/22

(52) U.S. Cl. CPC G02B 27/26; G02B 27/2228

(57) ABSTRACT

A three-Dimensional (3D) imaging method and device, generating a 3D image by only one imaging apparatus. The imaging apparatus is configured to perform the following three functions: converting source light to linear polarized light (S11), transforming, by Faraday effect, the linear polarized light into mixed polarized light comprising two polarized lights having different polarization directions (S12), and displaying, according to the mixed polarized light, an image (S13). An observer can observe, via an ordinary polarized 3D glasses and from a left eye and right eye, images having the different polarization directions, thereby synthesizing a 3D image in a brain of the observer. As a result, comparing to adopting two imaging apparatuses in a conventional 3D image approach, the 3D imaging device can save an imaging apparatus for each 3D imaging system, thereby simplifying a system structure and reducing a system cost. Moreover, the polarized 3D glasses has a lower cost, saving an investment in the 3D glasses and further decreasing the system cost.

### TECHNICAL FIELD

The present invention relates to the field of optical technology; and particularly to a 3D imaging method and device.

### BACKGROUND ART

With the developments in three-dimensional (three dimensions, 3D) imaging technology, the application of 3D imaging has spread into many areas of industrial design, mold design, film and television animation, etc. It is able to bring people real and three-dimensional visual enjoyment. Traditional 3D imaging systems use two projection devices with the same parameters to alternately project the images for the left eye and the images for the right eye, and then corresponding 3D glasses are used to allow the images for the left eye and the images for the right eye to enter the eyes via corresponding lenses at the right time; accordingly, the brain of a user can create a 3D image with real depth and free of ghosting images on the basis of the parallax between the left and right eye.

However, the foregoing 3D imaging system uses two projectors to project left- and right eye images, which not only makes the system have a complex structure, but also increases the costs of the system. On the other hand, the 3D glasses used along with the projection devices are typically in one of the two following modes: shutter type and polarized type. In the case when shutter type 3D glasses are utilized, the system costs will be further increased. In particular in a theater, many 3D glasses and associated apparatuses need to be provided, which will make the costs even higher. Nevertheless, in the case when polarized-type 3D glasses are utilized, a serious ghosting issue may occur, which will compromise 3D effects and cause eye fatigue. Therefore, the questions about how to reduce the cost of 3D imaging systems and at the same time ensure the quality of the generated 3D effect becomes an urgent problems in the art.

### SUMMARY OF THE INVENTION

In order to overcome the deficiencies in the related technologies, the present application provides a 3D imaging method and device.

A first aspect of the present invention provides a 3D imaging method. The 3D imaging method comprises the following steps:

converting a source light to a linear polarized light via a polarization device;

emitting the linear polarized light into an isotropic medium applied with an alternating magnetic field, so as to obtain a mixed polarized light, wherein the mixed polarized light comprises a first linear polarized light and a second linear polarized light, each of which has a fixed vibration plane angle, and a vibration plane of the first linear polarized light is parallel to the vibration plane of the linear polarized light;

performing an image display according to the mixed polarized light, such that an observer is able to obtain a first target image corresponding to the first linear polarized light obtained via a first polarity detection device corresponding to the first linear polarized light, and obtain a second target image corresponding to the second linear polarized light obtained via a second polarity detection device corresponding to the second linear polarized light.

In reference to the first aspect of the present invention, in the first implementable embodiment in the first aspect of the present invention, the step of performing an image display according to the mixed polarized light comprises performing the image display for the mixed polarized light via a digital micro-mirror device.

In reference to the first aspect of the present invention, in the first implementable embodiment in the first aspect of the present invention, the step of performing an image display according to the mixed polarized light comprises performing the image display for the mixed polarized light via a liquid crystal displaying.

A second aspect of the present invention provides a 3D imaging device, the device comprising a polarization module, a deflection module, and an imaging module;

wherein the polarization module is used for converting a source light to a linear polarized light;

the deflection module comprises an isotropic medium and an alternating magnetic field generator, and is used for deflecting a vibration plane of the linear polarized light, so as to obtain a mixed polarized light; wherein the mixed polarized light comprises a first linear polarized light and a second linear polarized light, each of which has a fixed vibration plane angle, and a vibration plane of the first linear polarized light is parallel to the vibration plane of the linear polarized light;

the imaging module is used for performing an image display according to the mixed polarized light, such that an observer is able to obtain a first target image corresponding to the first linear polarized light obtained via a first polarity detection device corresponding to the first linear polarized light, and obtain a second target image corresponding to the second linear polarized light obtained via a second polarity detection device corresponding to the second linear polarized light.

In reference to the second aspect of the present invention, in the first implementable embodiment in the second aspect of the present invention, the imaging module comprises a digital micro-mirror device.

In reference to the second aspect of the present invention, in the first implementable embodiment in the second aspect of the present invention, the imaging module comprises a liquid crystal displaying device.

In light of the foregoing technical solution, the embodiment of the present invention is able to achieve 3D imaging through only one set of imaging device, wherein the imaging device has the following three functions: converting source light to linear polarized light, transforming, by the Faraday Effect, the linear polarized light into mixed polarized light comprising two polarized lights having different polarization directions, and displaying, according to the mixed polarized light, an image. An observer can observe, via ordinary polarized 3D glasses and from a left eye and right eye, images having the different polarization directions, thereby synthesizing a 3D image in a brain of the observer. As a result, comparing to adopting two imaging apparatuses in a conventional 3D image approach, the 3D imaging device can spare one set of imaging device for each 3D imaging system, thereby simplifying a system structure and reducing a system cost. Moreover, the polarized 3D glasses have a lower cost, saving an investment in the 3D glasses and further decreasing the system cost.

It should be understood that both the foregoing general description and the details provided subsequently in the description are exemplary description, rather than limiting of the scope of the present application.

### BRIEF DESCRIPTION OF THE DRAWINGS

Drawings provided herein are incorporated into the Description of the present application, and thus constituting a part of the Description. The drawings illustrate the embodiments according to the present invention, which, together with the Description, serve to explain the principles of the present invention.

FIG. 1 is a flow chart of the 3D imaging method provided by an embodiment of the present invention.

FIG. 2 is a view showing the mechanism of the Faraday Effect utilized by an embodiment of the present invention.

FIG. 3 is a view showing the mechanism of the 3D imaging method provided in an embodiment of the present invention.

FIG. 4 is a schematic view of the structure of the 3D imaging device provided in an embodiment of the present invention.

### DESCRIPTION OF THE EMBODIMENTS

The exemplary embodiments of the present invention will be further described in detail. The examples are provided in the Drawings. In the following description and the accompanying drawings, unless otherwise indicated, the same numerals in different figures denote the same or similar elements. The following exemplary embodiments described next do not include all the possible embodiments that are consistent with the present invention. Instead, they are only a few examples of the device and methods recited in the claims and are consistent with certain aspects of the present invention.

FIG. 1 is a flow chart of the 3D imaging method provided by an embodiment of the present invention. As shown in FIG. 1, the method comprises the following steps.

S11, converting a source light to a linear polarized light via a polarization devices;

S12, emitting the linear polarized light into an isotropic medium applied with an alternating magnetic field, so as to obtain a mixed polarized light;

wherein the mixed polarized light comprises a first linear polarized light and a second linear polarized light, each of which has a fixed vibration plane angle, and a vibration plane of the first linear polarized light is parallel to the vibration plane of the linear polarized light;

S13, performing an image display according to the mixed polarized light, such that an observer is able to obtain a first target image corresponding to the first linear polarized light obtained via a first polarity detection device corresponding to the first linear polarized light, and obtain a second target image corresponding to the second linear polarized light obtained via a second polarity detection device corresponding to the second linear polarized light.

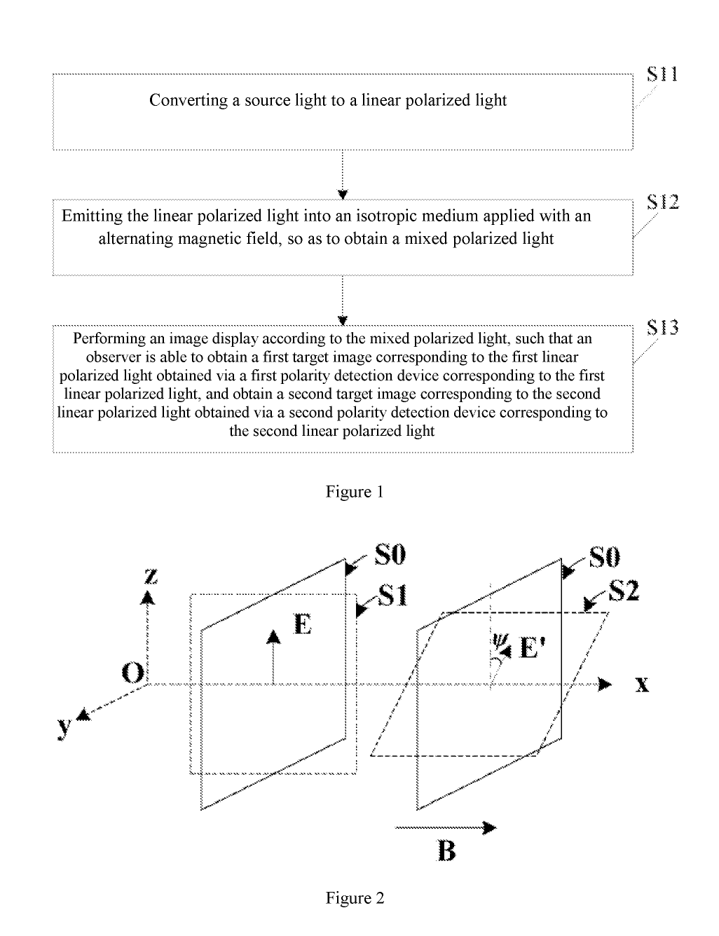

When the linear polarized light is transmitted in an isotropic medium (i.e., the physical and chemical properties of the medium do not change in different directions), under the effect of a magnetic field parallel to the light transmission direction, the vibration plane of the light will be deflected (in other words, the light vector is deflected). The foregoing phenomenon is known as the Faraday Effect, which is also known as the magneto-optical effect. The so-called vibration plane, in other words, the plane formed by the light's vibration direction and transmission plane, that is to say, the plane formed by the light vector direction and the light transmission direction. As shown in FIG. 2, in order to facilitate describing the respective vector directions, a spatial Cartesian coordinate system O-xyz has been established, in which the positive direction of x-axis is the direction of light transmission, the positive direction of z-axis is the direction of light vector E, accordingly, the vibration plane is the plane Si formed by x-axis and z-axis; when the light travels through a magnetic field B that is parallel to x-axis, the light vector E will rotate within a plane SO that is perpendicular to the light transmission direction with x-axis as the axis, so as to obtain the light vector E′. Accordingly, the vibration plane also rotates towards the direction of the negative direction of y-axis with x-axis as the axis; as a result, the vibration plane is altered from S1 to a plane S2 formed by E′ and x-axis. In the foregoing process, the rotation angle ψ of the light vector or the vibration plane is referred to as the Faraday angle, whose value can be calculated according to the following formula as ψ=VBd (B is magnetic field intensity, d is the length of the path the light travels through the magnetic field, and V is the Verdet constant).

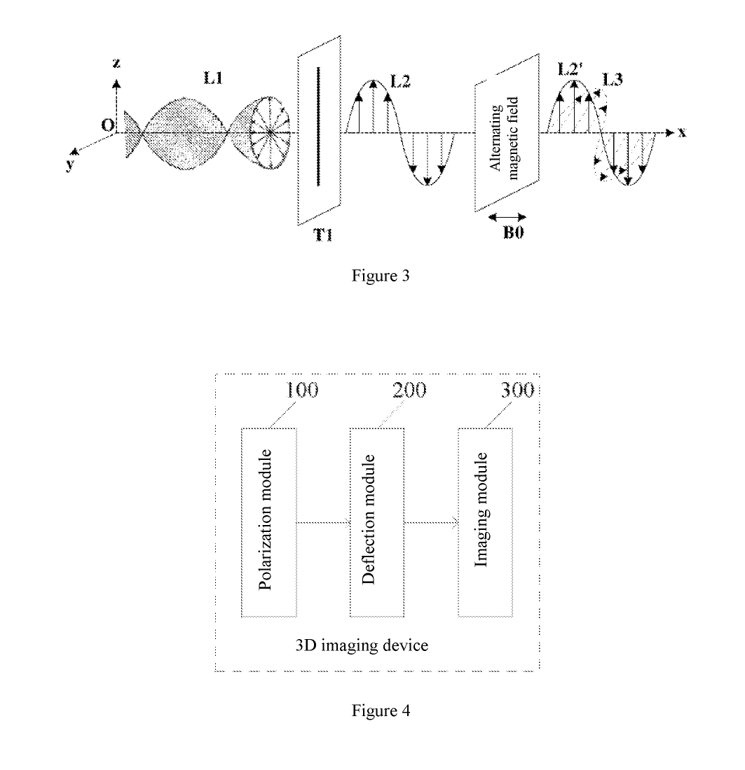

In the embodiment of the present invention, on the basis of the foregoing mechanism, a single linear polarized light is converted to two beams of linear polarized light having different light vector directions (i.e., the mixed polarized light) mentioned above. As shown in the mechanism provided in FIG. 3, in order to facilitate describing the related vectors and the directions thereof, a spatial Cartesian coordinate system O-xyz has been established, in which the positive direction of x-axis is the direction of light transmission. The source light L1 is a natural light (unpolarized light), and its light vector direction include all of the directions that are perpendicular to z-axis (that is to say, the directions of all the vectors within the plane formed by y-axis and z-axis).

In order to achieve the Faraday Effect, in step S11, the source light L1 is filtered through a polarization device T1 (for example, a polarizer), so as to obtain a linear polarization light L2 whose light vector directed can only be one of the two fixed opposite directions. For example, as shown in FIG. 3, the polarization device T1 only allows the light whose light vector direction is the positive direction or negative direction of z-axis to travel through (in other words, only the light that is parallel to the z-axis is allowed to travel through), and the light in other directions are filtered out. Accordingly, the waveform of L2 is the sine (cosine) curve in the rectangular coordinate system O-xz shown in FIG. 3.

In the step 512, under the effect of the alternating magnetic field B0, the linear polarized light L2 is deflected, wherein the magnetic field intensity of the alternating magnetic field is parallel to the transmission direction of L2. In addition, due to the fact that in a medium, no matter a linear polarized light travels along the direction of the magnetic field, or the direction opposing the direction of the magnetic field, the defection direction of the light vector does not change. As a result, over the course in which the intensity and direction of the alternating magnetic field B0 undergo a cyclic change, the direction of the Faraday angle – does not change; that is to say, when B is zero, ψ is zero, and L2 does not have a deflection; over the course in which B0 increases from zero towards the positive/negative maximum value, ψ increases and L2 has a deflection. Hence, under the effect of the alternating magnetic field, L2 alternates between the two states, deflection and non-deflection; such that a mixed polarized light formed by two linear polarized lights in different polarization directions is obtained. As shown in FIG. 3, the mixed polarized light comprises a first linear polarized light L2′ in the non-deflection state and a second linear polarized light L3′ in the deflection state (the vibration planes of L2′ and L3′ intersect on the x-axis).

In step S13, perform an image display according to the mixed polarized light; more specifically, the mixed polarized light (white light) is used as the incident light source, a prism is then used to convert the mixed polarized light to a colored mixed polarized light (according to the principle of three primary colors, the mixed colored polarized light comprises a first red linear polarized light whose polarized direction is the same as the first linear polarized light L2′, a first green linear polarized light and a first blue linear polarized light, as well as a second red linear polarized light whose polarized direction is the same as the second linear polarized light L3, a second green linear polarized light and a second blue linear polarized light). At the same time, a corresponding electrical control signal is formed according to the code information corresponding to the target image to be displayed, which is able to control the state of the switching element in the projection displaying device, such that the linear polarized light of a corresponding color is emitted and projected onto the display, screen or other types of medium to form a corresponding pixel block; and a combination of various pixel blocks forms the target image. Due to the fact that each color corresponds to the linear polarized lights in two polarized directions, when an observer is watching a target image on a display or screen, a first target image formed by the linear polarized lights in different colors and having the polarization direction identical to the polarization direction of L2′ can be obtained through a first polarization device T2 corresponding to L2′, and at the same time, a second target image formed by the linear polarized lights in different colors and having the polarization direction identical to the polarization direction of L3 can also be obtained through a second polarization device T3 corresponding to L3. Accordingly, one of the first target image and the second target image will become the image of left eye, while the other one will become the image of right eye. The two target images will be used in the brain of a user to form a corresponding 3D image. Specially, each of the T2 and T3 mentioned above can be a polarizer; further, the two can be the polarized lenses for left/right eyes in polarization 3D glasses.

Based on the above mechanism, it can be known that the embodiment of the present application is able to achieve 3D imaging through only one set of imaging device, wherein the imaging device has the following three functions: converting source light to linear polarized light, transforming, by Faraday Effect, the linear polarized light into mixed polarized light comprising two polarized lights having different polarization directions, and displaying, according to the mixed polarized light, an image. An observer can observe, via ordinary polarized 3D glasses and from a left eye and right eye, images having the different polarization directions, thereby synthesizing a 3D image in a brain of the observer. As a result, comparing to adopting two imaging apparatuses in a conventional 3D image approach, the 3D imaging device can spare one set of imaging device for each 3D imaging system, thereby simplifying a system structure and reducing a system cost. Moreover, the polarized 3D glasses have a lower cost, saving an investment in the 3D glasses and further decreasing the system cost.

Based on the different displaying positions of the target image, the 3D imaging method provided in the resent invention can be applied to the areas including near-eye displays, computers, TVs or other displaying devices to provide 3D display, as well as 3D movie display.

It is noted that as long as the component of the magnetic field in the light transmission direction is not equal to zero, regardless of the overall direction of the magnetic field, the Faraday Effect occurs. In this regard, in other embodiments of the present invention, the direction of the alternating magnetic field applied in step S12 does not have to be parallel to the light transmission direction, as long as the magnetic field has a component parallel to the light transmission direction.

In one implementable embodiment of the present invention, the foregoing step of performing an image display according to the mixed polarized light can be carried out by a variety of different devices, which include, but are not limited to, any one of the following devices: a digital micro-mirror device (Digital Micro-mirror Device, DMD), a liquid crystal displaying device (liquid crystal display, LCD).

In the embodiments described above, the source light is first polarized, and then subjected to a magnetic deflection treatment; subsequently a projection displaying device is utilized to decompose the light into the linear polarized lights with different wavelengths (i.e., different colors) to eventually form an image. In this way, the present invention is able to avoid the problem of partial image loss caused by that some light with certain specific wavelengths may have incorrect deflection angle under the effect of the magnetic field, such that the quality of the formed 3D image can be ensured.

FIG. 4 is a schematic view of the structure of the 3D imaging device provided in an embodiment of the present invention. In reference to FIG. 4, the device provided in the present invention comprises a polarization module 100, a deflection module 200, and an imaging module 300.

In the device, the polarization module 100 is used for converting a source light to a linear polarized light. Specifically, the polarization module 100 can be a polarizer.

The deflection module 200 is used for deflecting the vibration plane of the linear polarized light according to the Faraday Effect, so as to obtain a mixed polarized light; wherein the mixed polarized light comprises a first linear polarized light and a second linear polarized light, each of which has a fixed vibration plane angle, and a vibration plane of the first linear polarized light is parallel to the vibration plane of the linear polarized light.

More specifically, the deflection module comprises an isotropic medium and an alternating magnetic field generator, in which the isotropic medium can be a magneto-optic glass. In addition, by virtue of the alternating magnetic field generator, an alternating magnetic field is generated in the isotropic medium; as a result, when a linear polarized light travels through the alternating magnetic field, a cyclic deflection will be generated due to the Faraday Effect (in the case when the component of magnetic field intensity in the light transmission direction is equal to zero, the light will not be deflected; while as long as the component of magnetic field intensity in the light transmission direction is not equal to zero, the light will be deflected), so as to obtain the mixed polarized light mentioned above.

The imaging module 300 is used for performing an image display according to the mixed polarized light, such that an observer is able to obtain a first target image corresponding to the first linear polarized light obtained via a first polarity detection device corresponding to the first linear polarized light, and obtain a second target image corresponding to the second linear polarized light obtained via a second polarity detection device corresponding to the second linear polarized light.

In light of the foregoing device structure, it can be known that the embodiment of the present application is able to achieve 3D imaging through only one set of imaging device, wherein the imaging device has the following three functions: converting source light to linear polarized light, transforming, by Faraday Effect, the linear polarized light into mixed polarized light comprising two polarized lights having different polarization directions, and displaying, according to the mixed polarized light, an image. An observer can observe, via ordinary polarized 3D glasses and from a left eye and right eye, images having the different polarization directions, thereby synthesizing a 3D image in a brain of the observer. As a result, comparing to adopting two imaging apparatuses in a conventional 3D image approach, the 3D imaging device can spare one set of imaging device for each 3D imaging system, thereby simplifying a system structure and reducing a system cost. Moreover, the polarized 3D glasses have a lower cost, saving an investment in the 3D glasses and further decreasing the system cost.

In one implementable embodiment of the present invention, the imaging module 300 may include, but is not limited to, any of the following devices: a digital micro-mirror device, a liquid crystal displaying device.

In the embodiments described above, the source light is first polarized, and then subjected to a magnetic deflection treatment; subsequently a projection displaying device is utilized to decompose the light into the linear polarized lights with different wavelengths (i.e., different colors) to eventually form an image. In this way, the present invention is able to avoid the problem of partial image loss caused by that some light with certain specific wavelengths may have incorrect deflection angle under the effect of the magnetic field, such that the quality of the formed 3D image can be ensured.

After considering the description and practice of the present invention disclosed herein, a person of ordinary skill in the art will readily think of other embodiments of the present invention. The present application is intended to cover any variations, uses, or adaptations of the present invention. These variations, uses, or adaptations follow the general principles of the present invention and further include the general common knowledge and conventional technical means not disclosed in the present application yet are known in the art. The Description and examples shall be considered as exemplary descriptions only. The scope of the present invention shall be indicated by the claims provided below.

It should be understood that the present invention is not limited to the specific structure described above and illustrated in the accompanying drawings. Without departing from the scope of the present invention, various changes and modifications can be made to the present invention. Accordingly, the scope of the present invention is defined by the appended claims.

1. A 3D imaging method, characterized in that the method comprises:
converting a source light to a linear polarized light via a polarization device;
emitting the linear polarized light into an isotropic medium applied with an alternating magnetic field, so as to obtain a mixed polarized light, wherein the mixed polarized light comprises a first linear polarized light and a second linear polarized light, each of which has a fixed vibration plane angle, and the vibration plane of the first linear polarized light is parallel to the vibration plane of the second linear polarized light; and
performing an image display according to the mixed polarized light, such that an observer is able to obtain a first target image corresponding to the first linear polarized light obtained via a first polarity detection device corresponding to the first linear polarized light, and obtain a second target image corresponding to the second linear polarized light obtained via a second polarity detection device corresponding to the second linear polarized light.

2. The 3D imaging method according to claim 1, characterized in that the step of performing an image display according to the mixed polarized light comprises performing the image display for the mixed polarized light via a digital micro-mirror device.

3. The 3D imaging method according to claim 1, characterized in that the step of performing an image display according to the mixed polarized light comprises performing the image display for the mixed polarized light via a liquid crystal displaying device.

4. A 3D imaging device, characterized in that the device comprises a polarization module, a deflection module, and an imaging module;
wherein the polarization module is used for converting a source light to a linear polarized light;
the deflection module comprises an isotropic medium and an alternating magnetic field generator, and is used for deflecting a vibration plane of the linear polarized light, so as to obtain a mixed polarized light; wherein the mixed polarized light comprises a first linear polarized light and a second linear polarized light, each of which has a fixed vibration plane angle, and a vibration plane of the first linear polarized light is parallel to the vibration plane of the second linear polarized light; and
the imaging module is used for performing an image display according to the mixed polarized light, such that an observer is able to obtain a first target image corresponding to the first linear polarized light obtained via a first polarity detection device corresponding to the first linear polarized light, and obtain a second target image corresponding to the second linear polarized light obtained via a second polarity detection device corresponding to the second linear polarized light.

5. The 3D imaging device according to claim 4, characterized in that the imaging module comprises a digital micro-mirror device.

6. The 3D imaging device according to claim 4, characterized in that the imaging module comprises a liquid crystal displaying device.
